(19) United States
(12) Patent Application Publication
(10) Pub. No.: US 2016/0315378 A1
(43) Pub. Date: Oct. 27, 2016

(54) ANTENNA DEVICE

(71) Applicants: Hiroyuki KIRIYAMA, Katagami-shi (JP); Ryutaro MIURA, Katagami-shi (JP)

(72) Inventors: Hiroyuki KIRIYAMA, Katagami-shi (JP); Ryutaro MIURA, Katagami-shi (JP)

(73) Assignee: MITSUMI ELECTRIC CO., LTD., Tokyo (JP)

(21) Appl. No.: 15/099,222

(22) Filed: Apr. 14, 2016

(30) Foreign Application Priority Data
Apr. 23, 2015 (JP) 2015-088222

(51) Int. Cl. H01Q 1/32; H01Q 1/12; H01Q 1/40; H01Q 1/36

(52) U.S. Cl. CPC H01Q 1/3275; H01Q 1/362; H01Q 1/1214; H01Q 1/40

(57) ABSTRACT

Provided is an antenna device having a reduced height and enhanced receiving sensitivity. The antenna device includes an antenna base and an antenna cover fixed to the antenna base. The antenna cover includes a resin cover body and a capacitive element integrally molded with the cover body and functioning as at least any one of a capacitance hat and an inductor. The antenna device 1 further includes a helical element electrically connected to the capacitive element and an antenna board electrically connected to the helical element and disposed on the antenna base.

### BACKGROUND OF THE INVENTION

1. Field of the Invention

The present invention relates to an antenna device.

2. Description of the Related Art

Among vehicle antenna devices, telescopic rod antenna devices (hereinafter referred to as “rod antenna devices”) are generally used to receive amplitude-modulated (AM) and frequency-modulated (FM) broadcasting waves. Such a rod antenna device includes an antenna element (rod) having a length of approximately ¼ the wavelength λ of the FM waves (for example, 1.5 m for a resonant frequency of 50 MHz).

In such a rod antenna device, an antenna element adapted to the FM frequency band is used to receive AM waves. The antenna element has a resonant frequency mismatched to the AM frequency band and thus includes a resonant circuit and an amplifying circuit to ensure the sensitivity to AM waves. Another type of antenna device is known which includes an insulating rod with an antenna element (lead) spirally wound therearound (hereinafter referred to as “helical antenna device”) to reduce the length of the antenna to about 200 to 400 mm.

Unfortunately, the rod antenna (or helical antenna) device inevitably projects from a vehicle after being mounted thereto, which projection may impair the external appearance of the vehicle. Furthermore, the rod antenna device may be damaged by the collision with any obstacle, such as the roof of a garage, during the parking operation of the vehicle. The rod antenna device having an elongated length may generate a wind noise during the driving of the vehicle. This may bring an unpleasant feeling to the driver and passenger. Additionally, the rod antenna device is relatively easy to detach and is thus high-theft.

Still another vehicle antenna device is known which has an external appearance like a shark fin (shark fin antenna device) (refer to Japanese Unexamined Patent Application Publication (Translation of PCT Application) No. 2009-514253). The shark fin antenna device includes an antenna body for, for example, a global positioning system (GPS), a base on which the antenna body is disposed, and a shark-fin housing cover which is fixed to the base and accommodates the antenna body therein.

Another shark fin antenna device is known which includes an insulating body with an antenna element (lead) helically wound therearound. Such a shark fin antenna device can receive a wide range of waves from medium-frequency AM waves to very-high-frequency FM waves at high sensitivity (refer to Japanese Unexamined Patent Application Publication No. 2012-80388). Still another shark fin antenna device is known which includes a capacitive element and a coil element (refer to Japanese Unexamined Patent Application Publications No. 2009-135741 and No. 2013-229813).

Shark fin antenna devices have a lower height compared with rod antenna devices and helical antenna devices. Such shark fin antenna devices are in good coordination with the shapes of vehicles and thus can improve the external appearance of the vehicles and solve the problems described above.

A vehicle antenna device having a greater height from a mounting surface can have a higher receiving sensitivity to radio waves; however, the height of the vehicle antenna device is limited by a design constraint. In such a circumstance, demanded is a vehicle antenna device having a height within a limited range and enhanced receiving sensitivity to radio waves.

### SUMMARY OF THE INVENTION

The present invention has been made in view the above circumstance, and an object of the present invention is to provide an antenna device having a height which is less than or equal to a predetermined height (a reduced height) and enhanced receiving sensitivity to radio waves.

In order to achieve the above object, according to an aspect of the present invention, there is provided an antenna device including:

an antenna base;

an antenna cover fixed to the antenna base, the antenna cover comprising:
a resin cover body having a shape; and
a capacitive element integrally molded with the cover body, the capacitive element functioning as at least any one of a capacitance hat and an inductor;

a helical element electrically connected to the capacitive element; and

an antenna board electrically connected to the helical element, the antenna board being disposed on the antenna base.

Preferably, in the antenna device, the capacitive element is integrally molded with a part of the cover body, the part including the uppermost portion of the cover body.

Preferably, in the antenna device, the capacitive element has a shape conforming to the shape of the cover body.

Preferably, in the antenna device, the antenna device includes an antenna block around which the helical element is spirally wound, the antenna block supporting the helical element.

Preferably, in the antenna device, the antenna device includes a contact connector electrically connected to the helical element, wherein the capacitive element includes a connection connected to the contact connector for electrical connection between the capacitive element and the helical element.

Preferably, in the antenna device, the capacitive element has a plate shape, a wire-frame shape, a spiral shape, or a meandering shape.

Preferably, in the antenna device, the capacitive element has a plate shape and a hole for fixing the position of the capacitive element in a mold during the integral molding of the cover body and the capacitive element.

Preferably, in the antenna device, the capacitive element and the helical element are provided to have a length resonant at a predetermined frequency.

Preferably, in the antenna device, the antenna device is a vehicle antenna device, and the antenna cover has a streamlined shape flaring laterally and bulging upward toward the rear of the antenna cover along the longitudinal central axis of the antenna cover.

### BRIEF DESCRIPTION OF THE SEVERAL VIEWS OF THE DRAWINGS

The present invention is fully understood from the detailed description given hereinafter and the accompanying drawings, which are given by way of illustration only and thus are not intended to limit the present invention, wherein:

FIG. 1 is an external view of an antenna device according to an embodiment of the present invention.

FIG. 2 is a cross-sectional view of the internal structure of the antenna device.

FIG. 3 is a plan view of a capacitive element.

FIG. 4 is a perspective view of an antenna board and other components.

FIG. 5 is a perspective view of the antenna device from which an antenna cover is detached.

### DETAILED DESCRIPTION OF THE INVENTION

Embodiments of the present invention will now be described in detail with reference to the attached drawings. The examples shown in the drawings should not be construed to limit the present invention.

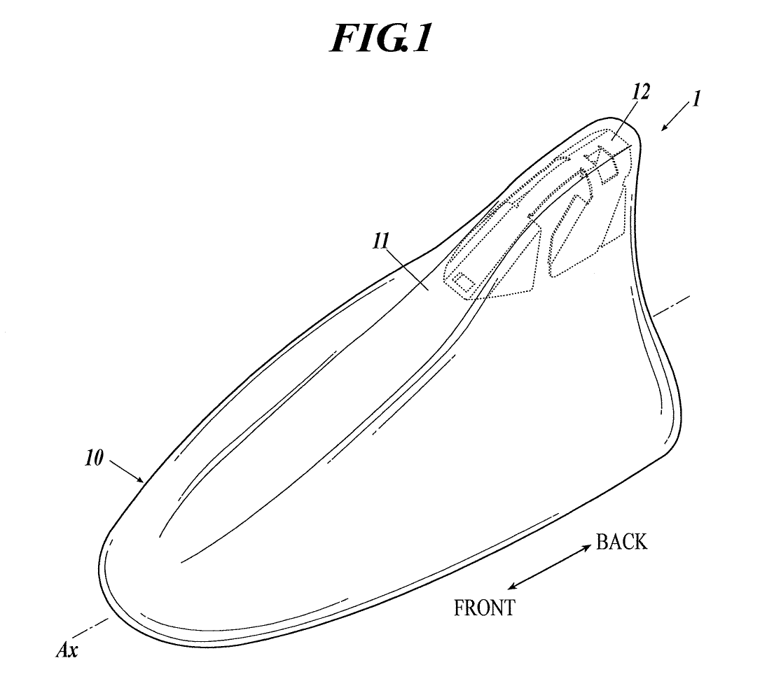

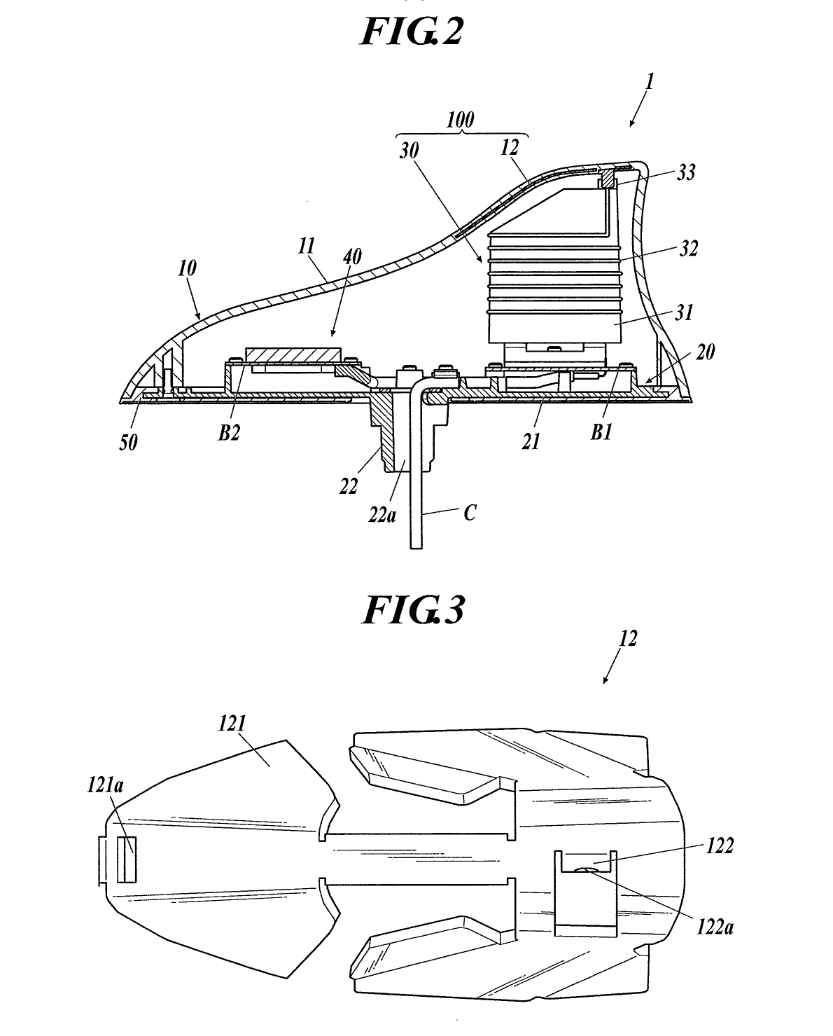

FIG. 1 is an external view of an antenna device 1 according to an embodiment of the present invention. FIG. 2 is a cross-sectional view of the internal structure of the antenna device 1. The antenna device 1 of the present invention is of a composite type which can receive radio waves having several frequency bands for a GPS and AM and FM broadcasting. The antenna device 1 is a vehicle antenna device to be fixed on a mounting surface, such as the roof of a vehicle.

With reference to FIGS. 1 and 2, the antenna device 1 includes an antenna cover 10, an antenna base 20, antenna boards B1 and B2, first and second antenna bodies 30 and 40, and a gasket 50. The first antenna body 30 is part of an antenna assembly to receive radio waves from AM and FM broadcasting stations. The second antenna body 40 receives radio waves from GPS satellites.

The height of the antenna device 1 from a contact surface (a mounting surface of the vehicle roof) is determined to be lower than a predetermined height for a design constraint. With reference to FIG. 1, the antenna cover 10 includes a cover body 11 and a capacitive element 12. The cover body 11 has a streamlined shape that flares laterally and bulges upward toward the rear along the longitudinal central axis Ax. The cover body 11 thus has a low-profile shark fin shape which is in good coordination with the external appearance of the vehicle.

The cover body 11 is a molded product composed of radio-wave transmissive and insulating synthetic resin, such as acrylic resin, and has an open bottom surface. Fixing the antenna base 20 and the gasket 50 to the bottom surface of the cover body 11 defines a space accommodating the first and second antenna bodies 30 and 40.

The capacitive element 12 is an antenna element composed of metal, such as copper and tin plate. The capacitive element 12 is formed by press-molding a metal plate into an appropriately bended shape conforming to the shape of the cover body 11.

FIG. 3 is a plan view of the capacitive element 12. With reference to FIG. 3, the capacitive element 12 includes a capacitive element body 121 and a connection 122. The capacitive element body 121 is molded into a streamlined shape conforming to the upper part (including the uppermost portion) of the cover body 11. The capacitive element 12 has punched holes or cut-away portions to prevent formation of creases during the press molding. The capacitive element body 121 has a hole 121a. The connection 122 is defined by a bent portion of the capacitive element body 121 and extends perpendicular to a plain surface of the antenna base 20. The connection 122 has a hole 122a.

The antenna cover 10 is manufactured through an integral molding (insert molding) process involving placing the capacitive element 12 into a mold of the cover body 11, injecting synthetic resin into the mold, and hardening the resin. The holes 121a and 122a function to fix the position of the capacitive element 12 in the mold of the cover body 11 during the integral molding. After the integral molding, at least the connection 122 of the antenna cover 10 is exposed from the inner surface of the cover body 11 defining the bottom opening of the cover body 11. The capacitive element 12 is integrally molded with the upper part including the uppermost portion of the cover body 11.

It is difficult to reduce the thickness of an antenna cover while its internal water-tightness and retention of the shape are being maintained. A typical antenna cover accommodates the entire antenna element; therefore the actual height of the antenna element is lower than a predetermined height limited by the design constraint. Such a reduction in height reduces the receiving sensitivity of the antenna device. In contrast, the antenna cover 10 is an integrally-molded product of the cover body 11 and the capacitive element 12; therefore the actual height of the antenna element is, compared with the conventional technology, substantially the same as the predetermined height limited by the design constraint. Such an antenna element can enhance the receiving sensitivity of the antenna device to radio waves.

The first antenna body 30 and the capacitive element 12 are collectively referred to as an antenna assembly 100. The antenna assembly 100 receives radio waves from AM and FM broadcasting stations. The capacitive element 12 functions as a capacitance hat and an inductor of the antenna assembly 100.

With reference to FIG. 2, the antenna base 20 includes a base member 21, a protrusion 22, and a clamp plate 23 and a clamp 24 that are described below. The base member 21 and the protrusion 22 are formed into an integrated die cast composed of metal, such as aluminum. The base member 21 has a substantially planar shape conforming to the bottom opening of the antenna cover 10 and is provided with antenna boards B1 and B2 on its upper surface. The protrusion 22 is placed into a fixing opening (not shown in the drawings) on the roof of a vehicle to mount the antenna device 1 to the vehicle. The protrusion 22 is shaped into an externally threaded bolt having a groove 22a extending along the axis of the protrusion 22. The groove 22a receives a bundle of a first cable C for the first antenna body 30, a second cable C for the second antenna body 40, and other cables C. The bundle of the cables C is electrically connected to internal vehicle equipment (not shown). The vehicle equipment includes a receiver receiving at least GPS signals from GPS satellites and reception signals in response to radio waves from AM and FM broadcasting stations. The cables C are coaxial cables, for example.

To mount the antenna device 1 to the mounting surface of the vehicle roof, the protrusion 22 is placed into the fixing opening and is fastened with a fixing member, such as a nut (not shown), on the inner surface of the vehicle such that the mounting surface of the vehicle roof is held between the antenna device 1 and the fixing member. Mounting the antenna device 1 achieves electrical connection of the base member 21 to the mounting surface and grounding of the base member 21 through the vehicle body. The antenna cover 10 is fixed to the antenna base 20 with a screw extending through the rear surface of the base member 21 and engaging with an internally threaded portion of a boss on the inner surface of the cover body 11.

The antenna boards B1 and B2 include tuning circuits and amplifying circuits each selectively receiving a radio wave having a predetermined frequency. The antenna boards B1 and B2 are, for example, printed circuit boards (PCBs) fixed on the upper surface of the base member 21 with screws. The antenna board B1 is dedicated to the first antenna body 30, and is electrically connected to first antenna body 30 and the first cable C.

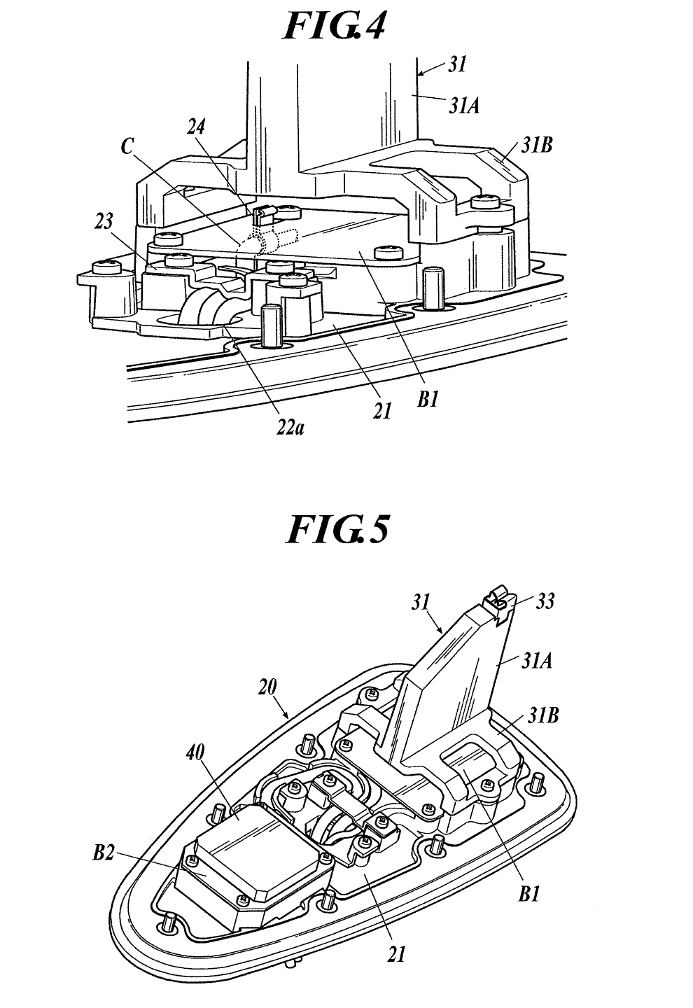

FIG. 4 is a perspective view of the antenna board B1 and the other components. With reference to FIG. 4, the bundle of the cables C extracted through the groove 22a of the protrusion 22 is fixed with the clamp plate 23 and the first cable C is electrically connected to the antenna board B1. The first cable C is a coaxial cable extending through a cable hole of the clamp 24. The external conductor of the first cable C is electrically connected to the clamp 24. The tip of the clamp 24 through which the first cable C extends is inserted into a hole of the antenna board B1 and is soldered. The clamp 24 is thereby electrically connected to a ground on the antenna board B1. The internal, conductor (core) of the first cable C is connected to an antenna-current output terminal of the antenna board B1. An antenna current generated upon the reception of radio waves at the antenna assembly 100 is transmitted to the receiver of the vehicle equipment through the antenna board B1 and the first cable C.

The antenna board B2 is dedicated to the second antenna body 40, and is electrically connected to the second antenna body 40 and the second cable C.

With reference to FIG. 2, the first antenna body 30 includes an antenna block 31, a helical element 32, and a contact connector 33. FIG. 5 is a perspective view of the antenna device 1 from which the antenna cover 10 is detached.

With reference to FIG. 5, the antenna block 31 is composed of insulating resin, such as acrylonitrile butadiene styrene (ABS), and is provided with a plate 31A and a foot 31B. The plate 31A is positioned such that the short side of the plate 31A is parallel to the longitudinal central axis Ax. The plate 31A is wound with the helical element 32. The plate 31A is partially chamfered to conform to the shape of the antenna cover 10. The plate 31A has a groove or grooves receiving the helical element 32 wound around the plate 31A, for example. The foot 31B is integrated with the plate 31A and supports the plate 31A with a space from the antenna board 31 to prevent the contact of the plate 31A with a circuit section of the antenna board 31. The plate 31A is fixed to the base member 21 with screws.

The helical element 32 is a lead wound around the antenna block 31 at a predetermined pitch in a vertical direction. The helical element 32 is, for example, an insulated enamel lead having an outer diameter of 1.0 mm, in view of ease of manufacturing, ease of processing, and isolation of the helical element 32. The helical element 32 is electrically connected to a feeding point of the antenna board B1 at its one end, and to the contact connector 33 at the other end. Such a first antenna body 30 has a so-called middle load structure in which the helical element 32 is disposed and connected midway between the capacitive element 12 and the feeding point of the antenna board B1.

The contact connector 33 is composed of soft metal, such as tinned brass, and has an M shape. The contact connector 33 holds the connection 122 of the capacitive element 12 therein so that the contact connector 33 is electrically connected to the capacitive element 12.

As described above, the antenna assembly 100 includes the capacitive element 12, the contact connector 33 and the helical element 32 that are connected in series in this order, and receives AM and FM radio waves as a radio antenna. The length of the helical element 32 is determined such that the capacitive element 12, the contact connector 33 and the helical element 32 are arranged to have an antenna length (for example, ¼ wavelength) that resonates in a frequency band (76 to 108 MHz) for FM broadcasting. It should be noted that the length of the helical element 32 is determined in consideration of the effect of the capacitance of the capacitive element 12 on a reduction in length of the helical element 32 described below and the effect of the pitch of the helical element 32 on a reduction in frequency. The antenna assembly 100 functions as a non-resonant antenna in a frequency band for AM broadcasting.

The capacitive element 12 functions as a capacitance hat to generate capacitance between the capacitive element 12 and the contact surface of the vehicle roof. This capacitive element 12 can reduce the height of the antenna assembly 100 while preventing a reduction in receiving efficiency of the antenna device 1. The resonant frequency of the helical element 32 is controlled by the length of the helical element 32, and is matched to the frequency band for FM broadcasting. The helical element 32 also functions as an inductor. As the pitch of a helical element decreases, the Q-value increases. The helical element 32 is therefore wound at an optimal pitch and at equal intervals to provide a predetermined Q-value.

In a preferred embodiment, the helical element 32 is wound at a pitch of 2 mm or greater to reduce the Q-value and to increase a bandwidth. As described above, to improve antenna performance, for example, to facilitate tuning and to enhance the receiving sensitivity, the pitch of the helical element 32 and the height of the antenna assembly 100 should preferably be increased as much as possible.

Alternatively, the helical element 32 may be wound at different pitches. For example, the pitches may gradually vary along the axial direction of the helical element 32. Such partial variations in pitch of the helical element 32 can readily control the resonant frequency of the antenna assembly 100, and can simplify the manufacture of the antenna assembly 100.

The second antenna body 40 is a patch antenna for a GPS and is electrically connected to the antenna board B2. The gasket 50 is composed of a waterproof and chemical-resistant elastic material, such as petroleum-based rubber, which may be ethylene propylene diene monomer (EPDM) rubber. The gasket 50 is provided around the base member 21. After the placement of the protrusion 22 in the fixing opening of the vehicle and the fastening of the protrusion 22 with the fixing member, the gasket 50 is disposed between the base member 21 and the roof. Such a structure can achieve the water-tightness of the interiors of the antenna cover 10 and the vehicle.

According to the embodiment described above, the antenna device 1 includes the antenna base 20 and the antenna cover 10 water-tightly fixed to the antenna base 20. The antenna cover 10 includes the radio-wave transmissive and insulating cover body 11 and the capacitive element 12 integrally molded with the cover body 11 and functioning as a capacitance hat and an inductor. The antenna device 1 further includes the helical element 32 electrically connected to the capacitive element 12 and the antenna board B1 electrically connected to the helical element 32 and disposed on the antenna base 20.

The antenna cover 10 including the cover body 11 integrally molded with the capacitive element 12 can accommodate the antenna assembly 100 having an increased height from the contact surface, while maintaining its water-tightness and retention strength. The antenna device 1 thus has a height which is less than or equal to a predetermined height (a reduced height) and enhanced receiving sensitivity to radio waves.

The capacitive element 12 is integrally molded with the part of the cover body 11 including the uppermost portion of the cover body 11. Such a structure can maximize the length of the antenna assembly 100 from the contact surface of the antenna device 1. The antenna device 1 thus has a reduced height and more enhanced receiving sensitivity to radio waves.

The capacitive element 12 has a shape conforming to the shape of the cover body 11. Such a structure can more increase the height of the antenna assembly 100 in the antenna device 1 having a reduced height and can more enhance the receiving sensitivity of the antenna device 1 to radio waves.

The antenna device 1 includes the antenna block 31 wound with the helical element 32 and supporting the helical element 32. Such a helical element 32 can be readily manufactured and mounted.

The antenna device 1 includes the contact connector 33 electrically connected to the helical element 32. The capacitive element 12 includes the connection 122. The connection 122 is connected to the contact connector 33, and the capacitive element 12 is thereby electrically connected to the helical element 32. Such electrical connection between the capacitive element 12 and the helical element 32 can be readily established.

The capacitive element 12 having a plate shape can generate a large capacitance between the capacitive element 12 and the contact surface. This plate shape can reduce the length of the antenna assembly 100, while preventing a reduction in receiving efficiency of the antenna device 1.

The capacitive element 12 includes the holes 121a and 122a to fix the position of the capacitive element 12 in the mold of the cover body 11 during the integral molding. Such holes 121a and 122a can facilitate precise positioning of the capacitive element 12 in the cover body 11.

Since the capacitive element 12 and the helical element 32 each have a length resonant at a frequency of FM waves, the antenna assembly 100 can receive FM waves at high sensitivity. The antenna assembly 100 can function as a non-resonant antenna to receive AM waves. The antenna device I thus can receive a wider range of waves, for example, from medium-frequency AM waves to very-high-frequency FM waves at high sensitivity.

The antenna device 1 is a vehicle antenna device including the antenna cover 10 having a streamlined shape that flares laterally and budges upward toward the rear along the longitudinal central axis. The antenna device 1 thus has a low-profile shark fin shape. The antenna device 1 can have such an excellent design, keep the good external appearance of the vehicle, have a reduced risk of the collision with any obstacle, such as the roof of a garage, during the parking operation of the vehicle, prevent the generation of a wind noise during the driving of the vehicle, and is effectively low-theft.

The embodiments of the present invention achieved by the inventors have been described, but the present invention is not limited to these embodiments, and various modifications may be made without departing from the scope of the invention.

For example, the antenna device 1 may be designed to have any outer dimension as long as the antenna cover is integrally molded with the capacitive element.

In the above embodiments, the antenna cover 10 includes the capacitive element 12 having a plate shape conforming to the shape of the antenna cover 10; instead, the antenna cover 10 may include a capacitive element having any shape other than the plate. For example, the antenna cover 10 may include a capacitive element shaped into a wire frame, a spiral wire, or a zig-zag (meandering) shape. In a preferred embodiment, the capacitive element has a shape conforming to the shape of the antenna cover 10. The capacitive element shaped into a wire frame, a spiral wire, or a meandering shape and functioning as a capacitance hat and an inductor generates lower capacitance and has more inductance components than the plate capacitive element. In the above embodiment, the capacitive element 12 functions as a capacitance hat and an inductor; alternatively, the capacitive element may functions as a capacitance hat or an inductor.

In the above embodiment, the first antenna body 30 includes the antenna block 31 and the helical element 32 spirally wound around the antenna block 31; instead, the first antenna body 30 may have any other structure. For example, the first antenna body 30 may be a helical element 32 composed of a rigid air-core spring with no antenna block 31. Alternatively, the first antenna body 30 may include an antenna block 31 and a helical element 32 which is a copper foil having a conductive pattern and disposed on the surface of the antenna block 31, for example.

In the above embodiment, the first antenna body 30 has a middle load structure in which the helical element 32 is disposed and connected midway between the capacitive element 12 and the feeding point of the antenna board B1; instead, the first antenna body 30 may have any other structure. For example, the first antenna body 30 may have a top load structure in which the helical element 32 is disposed close to and is connected to the capacitive element 12, or may have a bottom load structure in which the helical element 32 is disposed adjacent to and is connected to the feeding point of the antenna board B1.

In the above embodiment, the capacitive element 12 is exposed from the inner surface defining the bottom opening of the antenna cover 10 (cover body 11); instead, the capacitive element 12 may have any other structure. For example, the capacitive element may be exposed from the top of the antenna cover (cover body). The exposed part of such a capacitive element should preferably be coated with a protective material which protects the capacitive element. A preferred protective material is a waterproof material, for example, to protect the capacitive element from rain. Such a structure of the capacitive element can increase the height of the antenna assembly including the capacitive element and the helical element and enhance the receiving sensitivity of the antenna device.

The antenna block 31 of the first antenna body 30 may have any shape other than the shapes described in the above embodiment. For example, the antenna block may be a triangular prism which has an isosceles triangle bottom and is laid sideways, an elliptic column, or an oval column. Additionally, the antenna device 1 may have antenna assemblies 100 having different functions and disposed along the longitudinal or lateral direction of the antenna device 1.

In the above embodiments, the antenna device 1 includes the antenna assembly 100 which receives radio waves in the frequency bandwidths for FM and AM broadcasting; instead, the antenna assembly 100 may have any other configuration. The antenna assembly 100 may have any configuration to receive waves of any other transmission scheme or waves in any other frequency bandwidth.

In the above embodiments, the antenna device 1 includes the second antenna body 40 and the antenna board B2 for a GPS; instead, the antenna device 1 may have any other structure. The second antenna body 40 and the antenna board B2 may be removed from the antenna device 1. In place of the second antenna body 40 and the antenna board B2, the antenna device 1 may have another antenna body, such as a patch antenna, and another antenna board for broadcasting involving any other transmission scheme, such as satellite radio broadcasting, which may be XM radio broadcasting.

The embodiments and variations of the present invention disclosed herein should be considered to be mere examples and not limitative in all respects. The scope of the present invention is defined not by the above descriptions but by the claims, and is intended to cover all the modifications having equivalent meanings to those of the claims or being within the scope of the claims.

This application is based upon and claims the benefit of priority under 35 17SC 119 of Japanese Patent Application No. 2015-088222 filed on Apr. 23, 2015, the entire disclosure of which, including the specification, claims, drawings and abstract, is incorporated herein by reference in its entirety.

What is claimed is:

1. An antenna device comprising:
an antenna base;
an antenna cover fixed to the antenna base, the antenna cover comprising:
a resin cover body having a shape; and
a capacitive element integrally molded with the cover body, the capacitive element functioning as at least any one of a capacitance hat and an inductor;
a helical element electrically connected to the capacitive element; and
an antenna board electrically connected to the helical element, the antenna board being disposed on the antenna base.

2. The antenna device according to claim 1, wherein the capacitive element is integrally molded with a part of the cover body, the part including the uppermost portion of the cover body.

3. The antenna device according to claim 1, wherein the capacitive element has a shape conforming to the shape of the cover body.

4. The antenna device according to claim 1, comprising an antenna block around which the helical element is spirally wound, the antenna block supporting the helical element.

5. The antenna device according to claim 1, comprising a contact connector electrically connected to the helical element, wherein the capacitive element comprises a connection connected to the contact connector for electrical connection between the capacitive element and the helical element.

6. The antenna device according to claim 1, wherein the capacitive element has a plate shape, a wire-frame shape, a spiral shape, or a meandering shape.

7. The antenna device according to claim 1, wherein the capacitive element has a plate shape and a hole for fixing the position of the capacitive element in a mold during the integral molding of the cover body and the capacitive element.

8. The antenna device according to claim 1, wherein the capacitive element and the helical element are provided to have a length resonant at a predetermined frequency.

9. The antenna device according to claim 1,
wherein the antenna device is a vehicle antenna device, and
the antenna cover has a streamlined shape flaring laterally and bulging upward toward the rear of the antenna cover along the longitudinal central axis of the antenna cover.
